(19) United States
(12) Patent Application Publication
(10) Pub. No.: US 2014/0223062 A1
(43) Pub. Date: Aug. 7, 2014

(54) NON-AUTHORIZED TRANSACTION PROCESSING IN A MULTIPROCESSING ENVIRONMENT

(71) Applicant: INTERNATIONAL BUSINESS MACHINES CORPORATION, Armonk, NY (US)

(72) Inventor: Peter J. Relson, Ulster Park, NY (US)

(73) Assignee: INTERNATIONAL BUSINESS MACHINES CORPORATION, Armonk, NY (US)

(21) Appl. No.: 13/756,667

(22) Filed: Feb. 1, 2013

(51) Int. Cl. G06F 11/14; G06F 13/24

(52) U.S. Cl. CPC G06F 11/1405; G06F 13/24
USPC 710/267; 714/17

(57) ABSTRACT

A protocol for executing the instructions of a non-authorized transaction on the same processor in a multiprocessor environment is provided. A first instruction of a non-authorized transaction including a sequence of instructions is executed. A determination of whether the unauthorized transaction is aborted after each executed instruction. In response to an abort, the non-authorized transaction is rolled back and restarted at the first instruction of the non-authorized transaction. In response to an absence of an abort, the next instruction is executed until all sequenced instructions of the non-authorized transaction are completed on a same processing device.

### BACKGROUND

The present invention relates to multiprocessing, and more specifically, to providing a protocol for executing the instructions of a non-authorized transaction on the same processor in a multiprocessor environment.

In a contemporary multiprocessing environment, operating systems often include control structures that are processor-specific. These processor-specific control structures may only be referenced if a transaction is executing on a particular processor. Typically, a transaction requires authorization to utilize exclusive serialization protocols to ensure that the transaction will not be moved to another processor by the operating system. Without such authorization, a non-authorized transaction may not be able to follow a pointer chain to access data that is processor-specific, which may result in corrupted data.

### SUMMARY

According to an embodiment, a computer-implemented method provides a protocol for executing the instructions of a non-authorized transaction on the same processor in a multiprocessor environment. A first instruction of a non-authorized transaction including a sequence of instructions is executed by a processing device. A determination of whether the unauthorized transaction is aborted after each executed instruction. In response to an abort, the non-authorized transaction is rolled back and restarted at the first instruction of the non-authorized transaction. In response to an absence of an abort, the next instruction is executed until all sequenced instructions of the non-authorized transaction are completed on a same processing device.

According to another embodiment, a computer system including a first processing device, a system memory, and a bus that couples various system components including the system memory to the first processing device is configured to provide a protocol for executing the instructions of a non-authorized transaction on the same processor in a multiprocessor environment. A first instruction of a non-authorized transaction including a sequence of instructions is executed. A determination of whether the unauthorized transaction is aborted after each executed instruction. In response to an abort, the non-authorized transaction is rolled back and restarted at the first instruction of the non-authorized transaction. In response to an absence of an abort, the next instruction is executed until all sequenced instructions of the non-authorized transaction are completed on a same processing device.

According to another embodiment, a computer program product including a non-transitory computer readable storage medium having computer readable program code stored thereon that, when executed, provides a protocol for executing the instructions of a non-authorized transaction on the same processor in a multiprocessor environment. A first instruction of a non-authorized transaction including a sequence of instructions is executed. A determination of whether the unauthorized transaction is aborted after each executed instruction. In response to an abort, the non-authorized transaction is rolled back and restarted at the first instruction of the non-authorized transaction. In response to an absence of an abort, the next instruction is executed until all sequenced instructions of the non-authorized transaction are completed on a same processing device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a computer system according to an embodiment; and

FIG. 2 depicts a flow diagram of an operation for executing the instructions of a non-authorized transaction on the same processor in a multiprocessor environment according to an embodiment.

### DETAILED DESCRIPTION

Embodiments disclosed herein provide a protocol for ensuring that instructions of a non-authorized transaction are executed on the same processor in a multiprocessor environment.

Typically, the capability to instruct an operating system not to move a transaction to another processor and the capability to serialize the use of system resources (e.g., latching, locking, and enqueuing) are limited to authorized transactions running in a supervisor state or in Program Status Word (PSW) keys 0-7. Non-authorized transactions running in a problem state and PSW keys 8-15 do not have the capability to prevent the operating system from moving the non-authorized transaction to another processor or the capability to restrict the operation of an authorized transaction.

Because an operating system may move a non-authorized transaction to another processor due to an interrupt such as a time slice, the non-authorized transaction may end up referencing storage that is no longer valid. For example, a non-authorized transaction may not be able to load an address of a processor control block and then reference that block because an operating system may have moved the non-authorized transaction to a different processor, taken the original processor offline, and freed that control block. A Perform Locked Operation (PLO) instruction's “compare and load” function is available to non-authorized transactions. However, the “compare and load” function is limited to only one comparison and one load, so the query of interest must be resolvable with that amount of data. In other words, the “compare and load” function is limited to a one-level fetch.

Embodiments disclosed herein utilize the known constrained transaction function provided by a known Transaction Execution Facility (TEF) to atomically execute the instructions of a non-authorized transaction. The constrained transaction function ensures that all the instructions of a non-authorized transaction of an embodiment will be completed at some point without being aborted due to a conflict or interrupt. Moreover, embodiments disclosed herein provide multi-level fetches to storage blocks of the same processor for non-authorized transactions using the constrained transaction function.

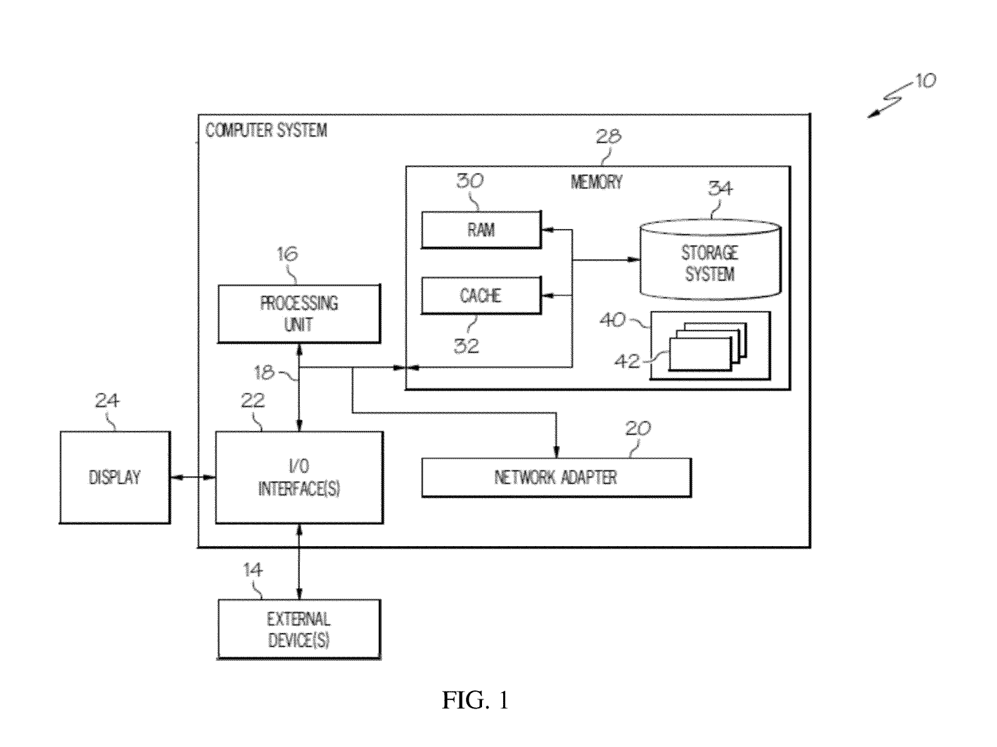

Referring now to FIG. 1, a block diagram of a computer system 10 suitable for executing the instructions of a non-authorized program on the same processor in a multiprocessor environment according to exemplary embodiments is shown. Computer system 10 is only one example of a computer system and is not intended to suggest any limitation as to the scope of use or functionality of embodiments described herein. Regardless, computer system 10 is capable of being implemented and/or performing any of the functionality set forth hereinabove.

Computer system 10 is operational with numerous other general purpose or special purpose computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a general-purpose computing device, also referred to as a processing device. The components of computer system may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, and data archival storage systems, etc.

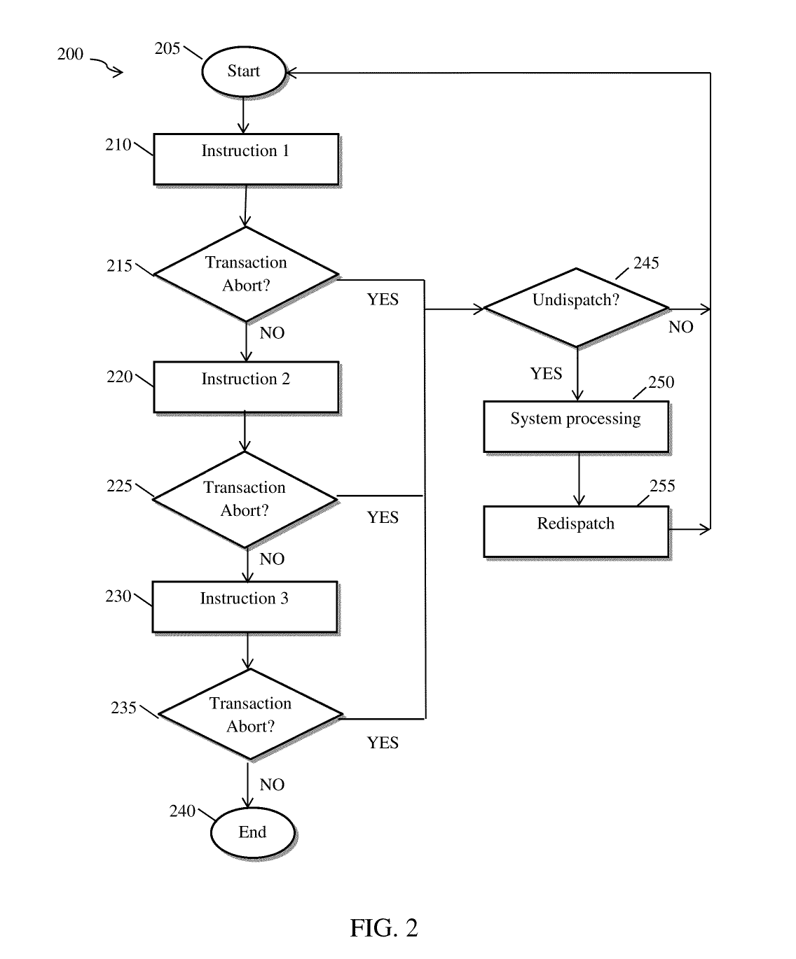

With reference now to FIG. 2, a flow diagram of an operation 200 for executing the instructions of a non-authorized transaction on the same processor in a multiprocessor environment according to an embodiment is shown.

An embodiment utilizes the known constrained transaction function provided by a Transaction Execution Facility (TEF) for executing the instructions of a non-authorized transaction atomically on the same processor. The constrained transaction function guarantees forward progress without requiring a failure handler. Two special machine instructions mark the beginning (TBEGINC) and end (TEND) of the constrained transaction. In between the TBEGINC and TEND instructions, a transaction can load and store from memory and alter registers. However, all the changes are provisional and uncommitted until the process ends the transaction without encountering an abort (e.g., a conflicting transaction or an interrupt). If an abort arises, the hardware aborts the transaction, including changes to memory, and the whole transaction starts over. According to an embodiment, the utilization of the constrained transaction function ensures that, at some point, all the instructions of a non-authorized transaction can be executed and completed on the same processor.

At block 205, a non-authorized transaction of an embodiment is initiated as a constrained transaction with a begin instruction (TBEGINC). At block 210, a first instruction is issued on a first processor of a multiprocessor according to an embodiment. For example, the first instruction may load into a register X1 from location x‘208’, which is the address of a Physical Configuration Communication Area (PCCA) address.

At block 215, an embodiment determines whether the constrained transaction has been aborted. The determination of whether the constrained transaction has been aborted is preferably implemented by the system hardware. According to an embodiment, the constrained transaction may be aborted due to reasons including, but not limited to, a conflict with another transaction or due to an external interrupt (e.g., time slice) or an input/output (I/O) interrupt (i.e., interrupts upon which an operating system may choose to move the constrained transaction to a different processor).

If the constrained transaction has not been aborted at block 215, an embodiment proceeds to issue a second instruction on the first processor as shown in block 220. For example, the second instruction may load into register X2 a Timer Queue Element (TQE) address from the PCCA block pointed to by register X1.

At block 225, an embodiment again determines whether the constrained transaction has been aborted. If the constrained transaction has not been aborted at block 225, an embodiment proceeds to issue a third instruction on the first processor as shown in block 230. For example, the third instruction may load into register X3 the field in the TQE that is of interest.

At block 235, an embodiment once again determines whether the constrained transaction has been aborted. If the constrained transaction has not been aborted at block 235, the constrained transaction has successfully completed on the first processor. At this point the constrained transaction is completed with an end instruction (TEND), as shown at block 240.

If, however, the constrained transaction has been aborted at any of blocks 215, 225, or 235, an embodiment further determines if the constrained transaction has been undispatched, as shown in block 245.

As discussed earlier, the constrained transaction may be aborted due to a conflict with another transaction or due an interrupt. In the case where the abort was caused by a conflict and the constrained transaction of an embodiment was not undispatched from the first processor, the constrained transaction is simply rolled back and restarted at block 205 on the first processor. In other words, in response to a conflict, the constrained transaction of an embodiment is rolled back to the beginning of the constrained transaction (block 205) and restarted on the first processor. Accordingly, an embodiment attempts to complete all the instructions of the constrained transaction on the first processor again.

If the constrained transaction has been aborted and undispatched by the operating system as shown at block 245, then the constrained transaction is subjected to some system processing as shown in block 250 prior to being redispatched as shown in block 255. According to an embodiment, the constrained transaction may be undispatched due to an external interrupt, such as a time slice, whereby the operating system may move the constrained transaction to another processor after a set amount of processing time for the constrained transaction expires. The constrained transaction of an embodiment may be redispatched to another processor. Therefore, the constrained transaction of an embodiment is rolled back and restarted on the new processor at block 205.

According to an embodiment, the constrained transaction of an embodiment guarantees that completion of the sequence of instructions of a transaction in the absence of an undispatch event 245 occurring at every iteration of the constrained transaction. For example, if an undispatch event 245 always occurred within the five instructions of begin/load/load/load/end of an embodiment, the constrained transaction may not complete. However, as known to those of ordinary skill in the art, a typical operating system does not undispatch as frequently as that. The undispatch event 245 may occur multiple times, but it would not occur all the time as known to those of ordinary skill in the art.

Embodiments disclosed herein provide a protocol for executing all the instructions of a non-authorized transaction program on the same processor in a multiprocessor environment. Moreover, embodiments disclosed herein provide multi-level fetches to storage blocks of the same processor for non-authorized transaction programs. The embodiments disclosed herein utilize the TEF's constrained transaction function within the architected constraints of the transaction (such as referencing only four octowords of data) to executing all the instructions of a non-authorized transaction program on the same processor in a multiprocessor environment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The disclosed flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method, comprising:
executing, on a first processing device, a first instruction of a non-authorized transaction, the non-authorized transaction comprising a sequence of instructions;
determining whether the unauthorized transaction is aborted after each executed instruction;
responsive to an abort, rolling back and restarting the non-authorized transaction at the first instruction of the non-authorized transaction; and
responsive to an absence of an abort, continuing to a next instruction until all sequenced instructions of the non-authorized transaction are completed on a same processing device.

2. The computer-implemented method of claim 1, wherein responsive to an abort, the method further comprises:
determining whether the non-authorized transaction was undispatched;
responsive to an undispatch, rolling back and restarting the non-authorized transaction on a second processing device; and
responsive to an absence of an undispatched, rolling back and restarting the non-authorized transaction on the first processing device.

3. The computer-implemented method of claim 2, wherein responsive to an undispatch, an operating system redispatches the non-authorized transaction to another processor.

4. The computer-implemented method of claim 1, wherein the non-authorized transaction is aborted due to at least one of a conflict or an interrupt.

5. The computer-implemented method of claim 4, wherein the interrupt comprises at least one of an external interrupt and an input/output (I/O) interrupt, the interrupt occurring between a constrained transaction begin instruction and a transaction end instruction.

6. The computer-implemented method of claim 1, wherein the non-authorized transaction is executed as a constrained transaction.

7. A computer system, comprising:
a first processing device, a system memory, and a bus that couples various system components including the system memory to the first processing device, the system configured to perform a method comprising:
executing, on the first processing device, a first instruction of a non-authorized transaction, the non-authorized transaction comprising a sequence of instructions;
determining whether the unauthorized transaction is aborted after each executed instruction;
responsive to an abort, rolling back and restarting the non-authorized transaction at the first instruction of the non-authorized transaction; and
responsive to an absence of an abort, continuing to a next instruction until all sequenced instructions of the non-authorized transaction are completed on a same processing device.

8. The computer system of claim 7, wherein responsive to an abort, the method further comprises:
determining whether the non-authorized transaction was undispatched;
responsive to an undispatch, rolling back and restarting the non-authorized transaction on a second processing device; and
responsive to an absence of an undispatched, rolling back and restarting the non-authorized transaction on the first processing device.

9. The computer system of claim 8, wherein responsive to an undispatch, an operating system redispatches the non-authorized transaction to another processor.

10. The computer system of claim 7, wherein the non-authorized transaction is aborted due to at least one of a conflict or an interrupt.

11. The computer system of claim 10, wherein the interrupt comprises at least one of an external interrupt and an input/output (I/O) interrupt, the interrupt occurring between a constrained transaction begin instruction and a transaction end instruction.

12. The computer system of claim 7, wherein the non-authorized transaction is executed as a constrained transaction.

13. A computer program product, comprising:
a non-transitory computer readable storage medium having computer readable program code stored thereon that, when executed, performs a method, the method comprising:
executing, on a first processing device, a first instruction of a non-authorized transaction, the non-authorized transaction comprising a sequence of instructions;
determining whether the unauthorized transaction is aborted after each executed instruction;
responsive to an abort, rolling back and restarting the non-authorized transaction at the first instruction of the non-authorized transaction; and
responsive to an absence of an abort, continuing to a next instruction until all sequenced instructions of the non-authorized transaction are completed on a same processing device.

14. The computer program product of claim 13, wherein responsive to an abort, the method further comprises:
determining whether the non-authorized transaction was undispatched;
responsive to an undispatch, rolling back and restarting the non-authorized transaction on a second processing device; and
responsive to an absence of an undispatched, rolling back and restarting the non-authorized transaction on the first processing device.

15. The computer program product of claim 14, wherein responsive to an undispatch, an operating system redispatches the non-authorized transaction to another processor.

16. The computer program product of claim 13, wherein the non-authorized transaction is aborted due to at least one of a conflict or an interrupt.

17. The computer program product of claim 16, wherein the interrupt comprises at least one of an external interrupt and an input/output (I/O) interrupt, the interrupt occurring between a constrained transaction begin instruction and a transaction end instruction.

18. The computer program product of claim 13, wherein the non-authorized transaction is executed as a constrained transaction.
